(19) United States
(12) Patent Application Publication
(10) Pub. No.: US 2008/0129446 A1
(43) Pub. Date: Jun. 5, 2008

(54) VEHICLE WITH HANDS-FREE DOOR

(76) Inventor: Scott J. Vader, Toronto (CA)

Correspondence Address: CESARI AND MCKENNA, LLP, 88 BLACK FALCON AVENUE, BOSTON, MA, 02210, US

(21) Appl. No.: 11/566,468

(22) Filed: Dec. 4, 2006

(51) Int. Cl. G05B 19/00

(52) U.S. Cl. 340/5.6; 340/686.6

(57) ABSTRACT

A system for hands-free vehicle door operation can selectively open a vehicle door on the approach of an operator. Thus, for example, with this system, a rear loading door of a delivery vehicle may open when the operator approaches so that the operator may enter the cargo bay when both hands are busy managing a load.

### BACKGROUND

This invention relates to a system for hands-free vehicle door operation, a vehicle incorporating such a system, and a related method.

Delivery trucks and vans are used extensively for the prompt movement of goods. A delivery vehicle may be loaded at a warehouse with packaged goods destined for a number of destinations and then driven along a route that incorporates each of the destinations in order to deliver the goods. Additionally, or alternatively, a delivery vehicle may pick up goods along a route for return to a warehouse or for delivery at another point, or points, along the route,

Given the high cost of labour, a delivery vehicle is typically operated by one person. At a destination point, the operator leaves the driver's seat and may enter the cargo bay of the vehicle in order to retrieve packaged goods for delivery. In a common delivery van configuration, the operator may access the cargo bay either through a door between the cab and the cargo bay or via a rear door of the van. The operator will typically choose to enter via the cab-to-cargo bay door when the packages for delivery may readily be carried. With larger deliveries, the operator will typically access the cargo bay via the rear door and will load the packages (e.g., boxes) onto a hand cart. Similarly, if the operator picks up packages at a destination, he will typically walk them into the cargo bay via the cab-to-cargo bay door if they may be readily carried, or will use a hand cart for more voluminous or heavy packages and will load such packages via the rear door of the vehicle.

It will be apparent that the work of moving packages into or out of a delivery vehicle will often require both hands of the operator. In consequence, the operator must interrupt the moving of packages where he/she must open or close an access door of the vehicle. Thus, for example, if the vehicle allows for a hand cart to be rolled onto or off of the vehicle through the rear door, in off loading packages, the operator may nevertheless be required to release the hand cart after leaving the vehicle with packages in order to close the rear door, or else risk unauthorised entry of the vehicle. Similarly, if the operator returns carrying a package, he/she may be required to set the package down in order to open the rear door or cab-to-cargo door in order to load the package.

Each additional operation that must be undertaken by an operator consumes time, thereby slowing the delivery process. Additionally, each operation of picking up or setting down a package increases operator strain, thereby risking injury and increasing operator fatigue.

Accordingly, an approach to ameliorate these problems would be advantageous.

### SUMMARY OF INVENTION

A system for hands-free vehicle door operation can selectively open a vehicle door on the approach of an operator. Thus, for example, with this system, a rear loading door of a delivery vehicle may open when the operator approaches so that the operator may enter the cargo bay when both hands are busy managing a load.

According to the present invention, there is provided a method of hands-free door operation of a vehicle comprising: opening a door upon sensing proximity of a key; closing said door after ceasing to sense proximity of said key.

The sensing may be wireless sensing and the key may be a wireless transmitter. The opening may be dependent upon receiving an indication door opening operations are active. The sensing proximity of the key may be sensing proximity to the door. The opening may occur upon sensing proximity of the key to the door inside the vehicle and upon sensing proximity of the key to the door outside the vehicle. The door may be a side door of a delivery vehicle.

The method may further comprise opening a second door upon sensing proximity of the key to the second door and closing the second door after ceasing to sense proximity of the key to the second door. The closing said second door may commence a pre-determined time after ceasing to sense proximity of the key. The second door may be a rear door of the vehicle.

The method may further comprise opening a cab-to-cargo bay door of the vehicle upon sensing the vehicle has been placed in park.

Each opening may be dependent upon receiving an indication door opening operations are active. The indication door opening operations are active may comprise a signal from a pressure switch under a driver's seat of the vehicle and/or may comprise a signal indicating the vehicle is in park.

Opening the side door may be further dependent upon receiving a side door opening mode indication. The vehicle may be caused to lie down after receiving the side door opening mode indication. Opening the rear door may be further dependent upon receiving a rear door opening mode indication. The vehicle may be caused to kneel after receiving the rear door opening mode indication.

A door may close a pre-determined time after ceasing to sense proximity of the key. If proximity of the key is sensed after ceasing to sense proximity of the key and the pre-determined time has not yet elapsed, the method may operate to refrain from closing the door after the pre-determined time has elapsed.

According to another aspect of the present invention, there is provided a system for hands-free vehicle door opening, comprising: a proximity sensor; a door motor for operating a door; a controller for receiving an input from said proximity sensor and for providing a control input to said door motor and for operating said door motor to open a door upon sensing proximity of a key and operating said door motor to close said door after ceasing to sense proximity of said key.

The system may further comprise a timer and the controller may be for timing after ceasing to sense proximity of the key and operating the door motor to close the door after a pre-determined time after ceasing to sense proximity of the key.

Other features and advantages will become apparent after a review of the following description and accompanying drawings.

### BRIEF DESCRIPTION OF THE DRAWINGS

In the figures which illustrate example embodiments of the invention,

FIG. 1A is a schematic plan view of a delivery vehicle embodying an aspect of this invention,

FIG. 1B is a schematic side view of the vehicle of FIG. 1A,

FIG. 2 is a block diagram showing electrical interconnections between elements, and

FIGS. 3A to 3C are flow diagrams illustrating operation of the system.

### DETAILED DESCRIPTION

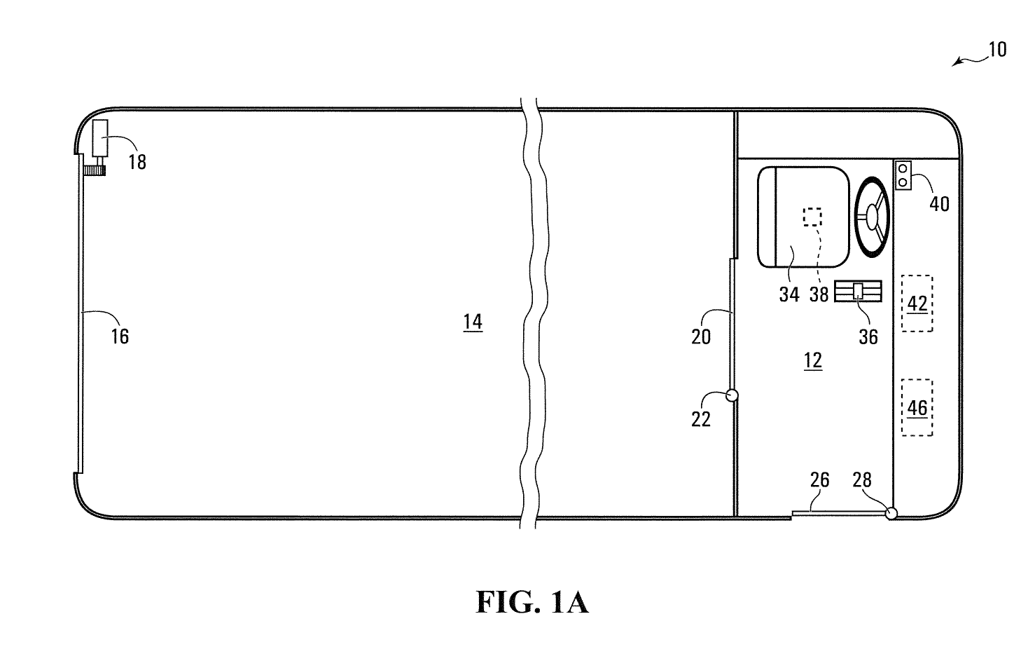

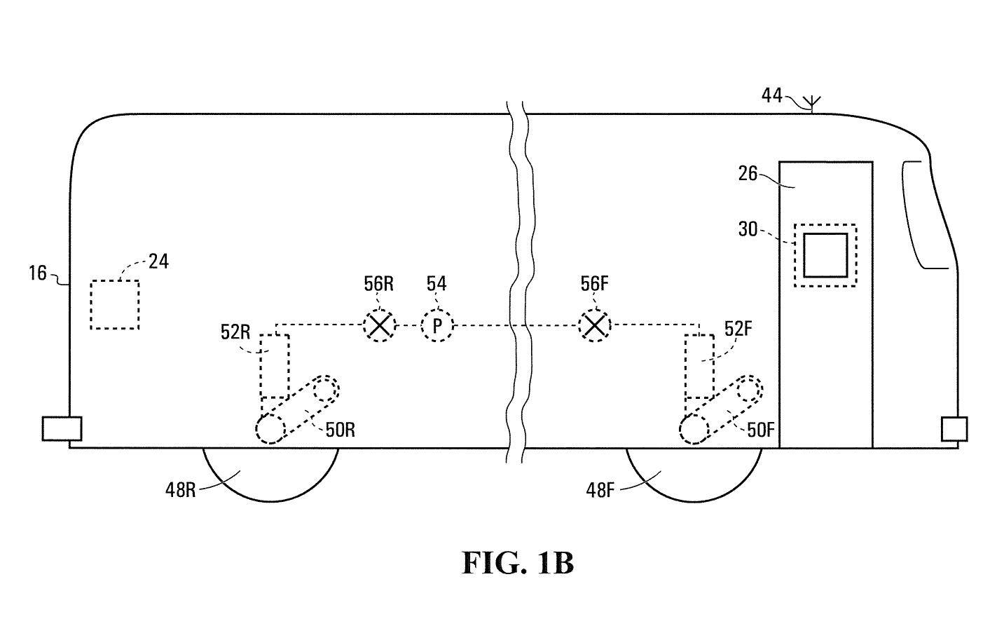

Turning to FIGS. 1A and 1B, a delivery vehicle 10 has an operator cab 12 and a cargo bay 14. The cargo bay has a rear loading door 16, which may be a roll-up door, operated by a motor 18 and a cab-to-cargo bay door 20 operated by a motor 22. A rear door proximity sensor, such as a directional antenna 24 coupled to a controller 46, is positioned to sense proximity of a key to the door 16. In this example embodiment the sensor includes a loop antenna embedded in the (fibreglass) body of the vehicle at the rear of the vehicle on the curb side which can sense the key when it is proximate either the outside or the inside of the door 16. Cab 12 may have an outwardly hinging side door 26 operated by a motor 28. A side door proximity sensor, such as a directional antenna 30 coupled to controller 46, is provided to sense proximity of the key to the side door. In this example embodiment, the side door proximity sensor includes a loop antenna embedded in side door 26 (around a window in the side door) which can sense the key when it is proximate either the outside or the inside of the door 26. As is conventional, the operator cab 12 has a driver's seat 34 and a gear shifter 36. A switch 38 may be positioned under the driver's seat 34 such that it switches when an operator sits on or leaves the seat. Additionally, the cab may have an on-dash mode selector 40 and a receiver 42 for receiving signals from a long range antenna 44.

The front wheels 48f and rear wheels 48r of the vehicle 10 may have respective independent suspensions 50f, 50r. Each of these suspensions may be supported by an air bladder 52f, 52r. Valves 56f, 56r may selectively vent the air bladders or couple them to pressurised air from pump 54.

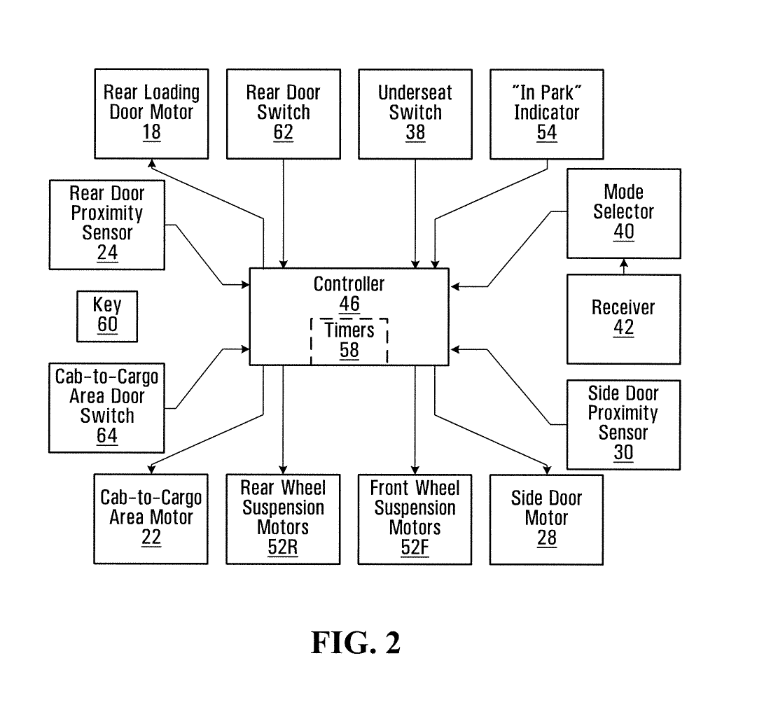

Referencing FIG. 2, controller 46 is connected to receive inputs from each of rear door antenna 24, side door antenna 30, underseat switch 38, mode selector 40, and “in park” indicator 54 associated with gear shifter 36. Controller 46 is also connected to output signals to rear loading door motor 18, cab-to-cargo bay motor 22, side door motor 28, and valves 56f and 56r. The controller has timers 58. The mode selector 40 may receive signals from receiver 42.

The controller may, for example, be a processor operating under software control or a configured field programmable gate array (FPGA). Each of motors 18, 22, and 28 may be an electric motor operatively connected to a battery associated with the vehicle; similarly, each of valves 56f, 56r may be an electric valve operatively connected to the vehicle battery. Each electric motor may have a three-way switch controlled by controller 46 such that the motor may be off or rotated in a clockwise or counterclockwise direction. The mode selector may be controlled from either or both of operator actuatable controls and receiver 42 to indicate a rear door loading mode, a side door loading mode, or a rear door locked open mode, amongst other possible modes. Optionally, the mode selector may also be controlled to indicate an “off” mode.

A key 60 may be carried by the operator. When the key 60 is sensed by either the rear door proximity sensor 24 or the side door proximity sensor 30, proximity signals are sent to controller 46. In the example embodiment, the key is a transmitter, such as a radio frequency identification (RFID) tag, which transmits a characteristic signal. Thus, when the key is in (directional and proximal) range of one of the antennae 24 or 30, the one antenna will receive characteristic signals from the key which it passes to the controller. The key 60 may, or may not, incorporate an ignition key for the vehicle.

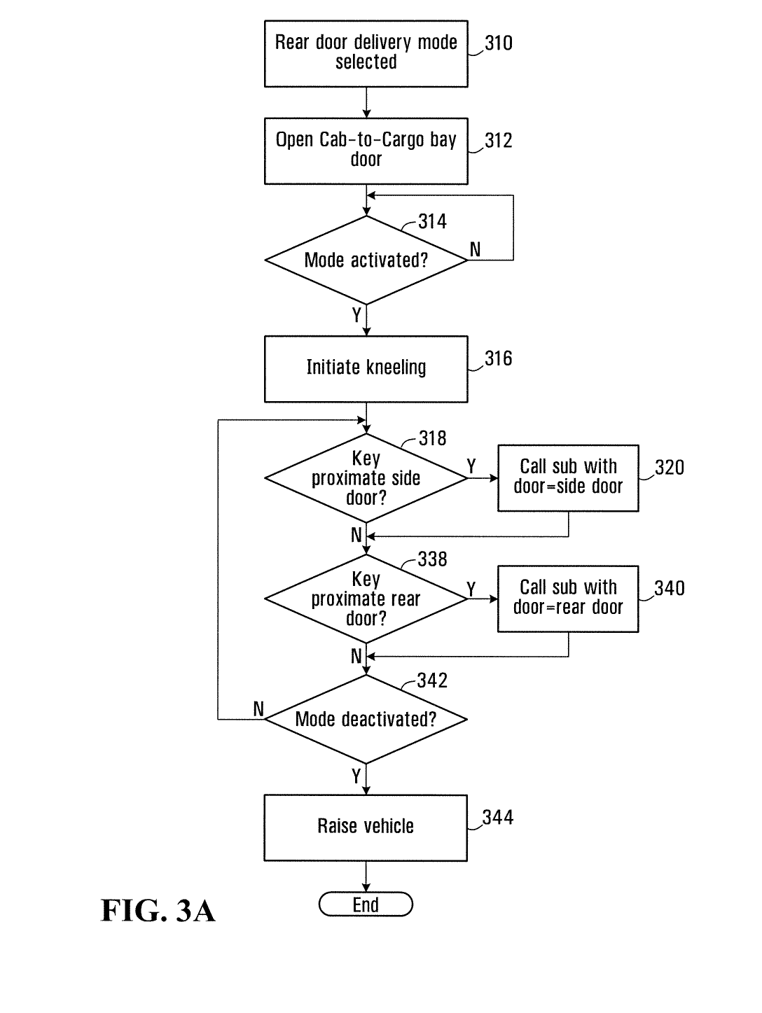

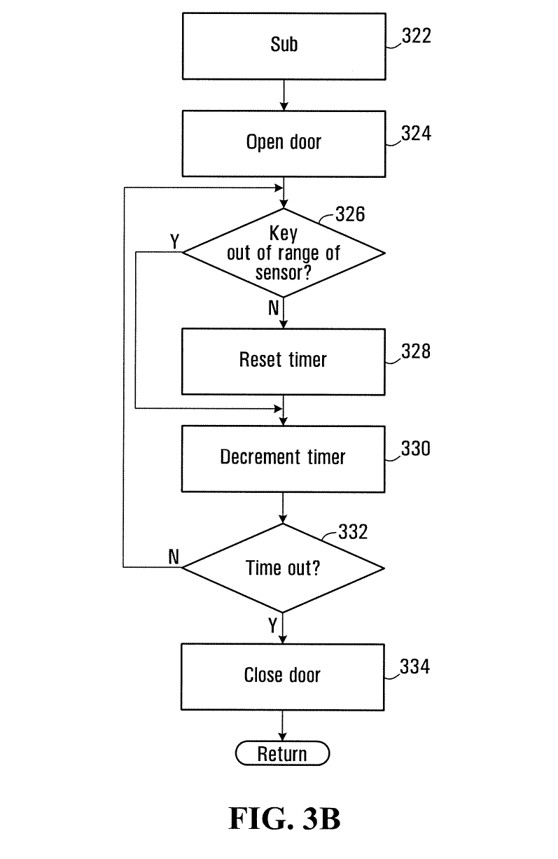

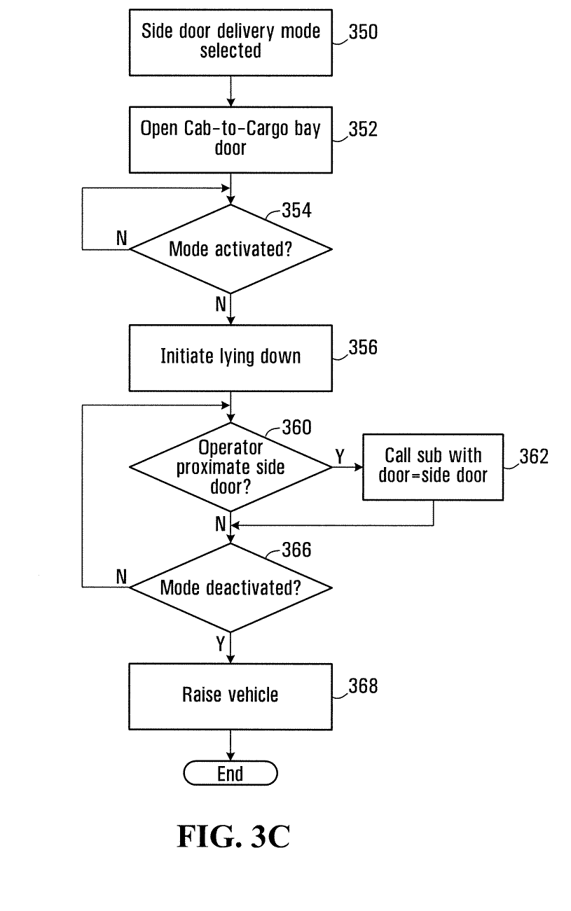

With reference to FIGS. 3A to 3C along with FIGS. 1A, 1B and 2, in a manual use of mode selector 40, the operator, knowing the task required for the next destination on his route, may manually select an appropriate mode on mode selector 40 while en route. This may be, for example, the rear door delivery mode. This mode indication inputs controller 46 (310). When the destination is reached, the operator may place the vehicle gear shift 36 in park. This causes an “in park” indication to be received by the controller. On receiving the “in park” signal, the controller may open the cab-to-cargo door 20 (312) and leave it open until receiving an “out of park” signal. When the operator rises from the driver's seat, this will cause underseat switch 38 to switch on. Once the controller has a signal from both the “in park” indicator 54 and underseat switch 38, it is in active rear door delivery mode (314). At this point, the controller controls valve 56r to empty the rear wheel air bladders 52r in order to retract suspensions 50r. This brings the rear of the body of the vehicle closer to the ground causing the vehicle to, in effect, kneel down (316). The vehicle may be designed so that, when kneeling, the rear end of the floor of the cargo bay is essentially at ground level.

If the operator, when in the cab, moves toward the side door so that key 60 is sensed by the side door proximity sensor (i.e., antenna 30 and controller 46) (318), the controller, in response, controls side door motor 28 to open the side door 26 (320, 322, 324). The operator, with the key on his person, may then egress the vehicle 10. Once the key moves out of range of the side door proximity sensor such that the controller 46 ceases to receive proximity signals from antenna 30 (326), it launches one of the timers 58 (330). When this timer times out (332), the controller controls motor 28 to close the side door 26 (334). However, if, while the timer is timing, the controller again receives proximity signals from the side door antenna 30, the launched timer is reset (328) and disabled until the proximity signals cease.

It may be, for example, that the operator leaves cab 12 with a hand cart and retrieves a number of boxes from the destination which are loaded onto the hand cart. As the operator negotiates the laden hand cart toward the vehicle 10, once the key on his person comes into range of the rear door proximity sensor, characteristic signals transmitted by the key are passed by antenna 24 of the sensor to the controller 46. The controller compares the received characteristic signals to stored representations of these signals. If there is a match (338), the controller activates the rear loading door motor 18 so as to open the rear door 16 (340, 324). Thus, with the vehicle kneeling, the operator is able to wheel the laden hand cart directly onto the vehicle without interrupting this task to manually open the door. With the antenna 24 on the curb-side of the vehicle at the rear of the vehicle, the operator, and therefore key 60 carried by the operator, will pass close to the sensor in the typical situation where the operator approaches vehicle 10 from the curb side. The proximity sensor may be designed to have a sufficient range (e.g., four feet) such that door 16 has time to open before the operator reaches the door. Consequently, the operator will not be delayed in loading the retrieved packages waiting for the door to open.

Once the controller ceases to recognise proximity signals from the input received from antenna 24 (326), the controller may launch one of timers 58 (330) and control motor 18 to close door 16 when the timer times out. However, if further proximity signals are received while the timer is timing, the timer is reset and disabled until the controller once more ceases recognising proximity signals. Thus, if the operator moves far enough away from the rear door 16 when inside the cargo bay, or after leaving the vehicle again, door 16 will eventually close. However, if the operator moves back toward the door 16, it will open again.

After entering the cargo bay via the rear door, the operator could return to the cab 12 through the cab-to-cargo door 20. Alternatively, if the operator leaves the vehicle and returns to the side door 26, once the key moves into range of the side door proximity sensor (which comprises antenna 30 and controller 46) (318), the controller will control the door's motor 28 to open the door (320, 322). The controller will again launch a timer 58 when the signal from antenna 30 is so attenuated that the controller ceases to recognise proximity signals so that the door 26 closes when the timer times out.

Once the operator resumes his seat, switch 38 is switched to a second position. This de-activates the rear door delivery mode (342) which causes the controller 46 to operate control valve 56r to raise the rear of the vehicle (344). When the gear shift 36 is taken out of park as the vehicle is about to leave, the cab-to-cargo door 20 will close.

If, rather than selecting the rear door delivery mode, the operator had selected the side door delivery mode (350), then, after placing the vehicle in park the cab-to-cargo door would open (352) and after leaving his seat, the side door delivery mode would be active (354). With the side door delivery mode active, the controller causes valves 56f and 56r to raise wheels 48f, 48r, respectively, in order to cause the vehicle to, in essence, lie down (356). With a suitably designed vehicle, this would bring the floor of the cab at the side door 26 closer to ground level. The operator may enter the cargo bay 14 and retrieve a number of packages, leaving via the cab-to-cargo bay door 20 unimpeded by door 20. When the side door proximity sensor senses the operator (360), the side door 26 opens (362, 322, 324) allowing egress from the vehicle, unimpeded by the door.

After timers 58 allocated by the controller time out, the side door 26 (334) will close. When the operator returns after delivery of the packages, possibly laden with additional packages picked up at the destination, the controller will cause side door 26 to open when his key is in range of sensor 30. Thus, the operator may enter the vehicle via the side door 26 and load packages into the cargo bay unimpeded by either of doors 26 and 20 and door 26 will thereafter automatically close.

Once the operator returns to his seat, switch 38 switches de-activating the side door delivery mode (366) and the controller causes valves 56f, 56r to couple pressurised air from pump 54 to the air bladders 52f, 52r in order to lower suspensions 50f, 50r and, therefore, wheels 48f, 48r to again raise the vehicle (368).

Optionally, rather than an operator manually selecting a mode at mode controller 40, a mode suitable to the destination may be downloaded from a base station by wireless transmission to receiver 42 via antenna 44. In this connection, the base station may track the position of the vehicle using a GPS system (not shown) and download the appropriate mode as the vehicle approaches a destination based on the current manifest for the vehicle.

While the example embodiment has been described showing all control for the various operations controlled by controller 46, it will be apparent that some operations may be controlled in a decentralised fashion. For example if, rather than providing a proximity sensor comprising an antenna and the controller, a proximity sensor were a self-contained unit, then side door 26 could be independently operated. More specifically, the self-contained sensor 30, whenever it sensed key 60, could send a control signal directly to motor 28 to open door 26 and to a local timer to re-set the timer. In such case, after door 26 was opened and the self-contained sensor ceased sending control signals, the local timer could time down in order to signal motor 28 to close the door. Similarly, a further self-contained proximity sensor could directly signal motor 18 to open door 16 when it sensed key 60 rather than signalling the controller, and a local timer could then control re-closing of the door. In such case, controller 46 would simply function to disable the rear door proximity sensor whenever the rear door delivery mode was not active.

While the proximity sensors have been described as loop antennae which output to the controller to allow the proximity of key 60 to be sensed when within or outside vehicle 10, in an alternate arrangement, each sensor may only sense the key when it is outside the vehicle. This may occur where, for example, there is metal in the doors behind the loop antennae which shields the antennae from sensing the key inside the vehicle. Where a sensor is only capable of sensing the key when outside a door, a separate sensor may be provided to sense the proximity of the key to the inside of the door. Alternatively, if the rear door sensor is only capable of sensing the key when outside the vehicle, a switch could be provided inside the cargo bay 14 of the vehicle to allow the operator to operate door 16 from within the cargo bay. Regarding door 26, as an alternative to a separate key sensor, a separate sensor, such as a pressure pad located just inside door 26, may be provided to directly sense the proximity of the operator to door 26.

While activation of the modes of operation has been described as dependent upon both the vehicle being placed in park and the switching of switch 38 as the operator leaves his seat, obviously the modes could be activated based on only one of these two operations. Indeed, the mode selector 40 could have an off setting, in which case activation of a mode could simply be as a result of an operator switching the mode selector from the off setting to a selected mode.

Cab-to-cargo door 20 has been described as opening when the gear shift 36 is placed in park and remaining open while the gear shift remains in park. In an alternate arrangement which enhances the security of the cargo when the operator has left the vehicle, a further sensor may be added to sense the presence of the operator in the vehicle. This sensor may include a loop antenna embedded in the roof of the vehicle which outputs to the controller. With this alternate arrangement, door 20 may open when the vehicle is placed in park but controller 46 may activate a local timer 58 to time down when the added (in-roof) sensor no longer senses key 60. If the timer times out, door 20 will close until the added sensor again senses the presence of the operator.

While vehicle kneeling and lying down can further reduce operator strain, operator strain is nevertheless reduced by the automatic door opening of this invention even in the absence of the vehicle kneeling and lying down. Therefore, in a more simplified embodiment, vehicle 10 may be incapable of one or both of the operations of kneeling and lying down.

While the key 60 has been described as a transmitter transmitting a characteristic signal, other key types are possible which would function with other types of proximity sensors. For example, each of the proximity sensors could be designed to set up an electric or magnetic field and the key could be designed to perturb this field in a certain way so as to be sensed when in sufficient proximity.

While, in the example embodiment, the vehicle 10 has a rear loading door 16 and a cab-to-cargo bay door 20, other delivery vehicles may have different door configurations. Thus, for example, a delivery vehicle may have a door on both sides of the cargo bay and no cab-to-cargo bay door. In such case, the mode of delivery may be selected to be via one or the other of the cargo bay side doors.

This invention also has application where there is only one mode of delivery, which mode may be selectively enabled or disabled as, for example, providing a mode selector with an “off” position. The “off” position provides enhanced security, especially in situations where the key is chosen as a low security key.

The timers of the controller could, of course, be separate timers.

The system of this invention may be installed in existing delivery vehicles as an after-market item (especially where the retracting suspensions are either not required or are already in place).

Other modifications will be apparent to those skilled in the art and, therefore, the invention is defined in the claims.

What is claimed is:

1. A method of hands-free door operation of a vehicle comprising:
opening a door upon sensing proximity of a key;
closing said door after ceasing to sense proximity of said key.

2. The method of claim 1 wherein said sensing is wirelessly sensing.

3. The method of claim 2 wherein said key is a wireless transmitter.

4. The method of claim 1 wherein said opening is dependent upon receiving an indication door opening operations are active.

5. The method of claim 1 wherein said sensing proximity of said key is sensing proximity to said door.

6. The method of claim 5 wherein said opening occurs upon sensing proximity of said key to said door inside said vehicle and upon sensing proximity of said key to said door outside said vehicle.

7. The method of claim 5 wherein said door is a side door of a delivery vehicle.

8. The method of claim 7 further comprising opening a second door upon sensing proximity of said key to said second door and closing said second door after ceasing to sense proximity of said key to said second door.

9. The method of claim 8 wherein said closing said second door commences a pre-determined time after ceasing to sense proximity of said key.

10. The method of claim 8 wherein said second door is a rear door of said vehicle.

11. The method of claim 10 further comprising opening a cab-to-cargo bay door of said vehicle upon sensing said vehicle has been placed in park.

12. The method of claim 8 wherein each said opening is dependent upon receiving an indication door opening operations are active.

13. The method of claim 12 wherein said indication door opening operations are active comprise a signal from a pressure switch under a driver's seat of said vehicle.

14. The method of claim 12 wherein said indication door opening operations are active comprise a signal indicating said vehicle is in park.

15. The method of claim 12 wherein opening said side door is further dependent upon receiving a side door opening mode indication.

16. The method of claim 15 further comprising causing said vehicle to lie down after said receiving said side door opening mode indication.

17. The method of claim 15 wherein opening said rear door is further dependent upon receiving a rear door opening mode indication.

18. The method of claim 17 further comprising causing said vehicle to kneel after said receiving said rear door opening mode indication.

19. The method of claim 1 wherein said closing commences a pre-determined time after ceasing to sense proximity of said key.

20. The method of claim 19 wherein if proximity of said key is sensed after ceasing to sense proximity of said key and said pre-determined time has not yet elapsed, refraining from closing said door after said pre-determined time has elapsed.

21. A system for hands-free vehicle door opening, comprising:
a proximity sensor;
a door motor for operating a door;
a controller for receiving an input from said proximity sensor and for providing a control input to said door motor and for operating said door motor to open a door upon sensing proximity of a key and operating said door motor to close said door after ceasing to sense proximity of said key.

22. The system of claim 20 further comprising a timer and wherein said controller is for timing after ceasing to sense proximity of said key and operating said door motor to close said door after a pre-determined time after ceasing to sense proximity of said key.
